(19) United States
(12) Patent Application Publication
(10) Pub. No.: US 2023/0260411 A1
(43) Pub. Date: Aug. 17, 2023

(54) DETECTION METHOD OF DECOYING OF A TRAFFIC ALERT AND COLLISION AVOIDANCE SYSTEM, AND ASSOCIATED TRAFFIC ALERT AND COLLISION AVOIDANCE SYSTEM

(71) Applicant: THALES, Courbevoie (FR)

(72) Inventors: Kevyn LEDIEU, MERIGNAC (FR); Denis RICAUD, MERIGNAC (FR); Nathalie FEYT, MERIGNAC (FR)

(21) Appl. No.: 18/107,721

(22) Filed: Feb. 9, 2023

(30) Foreign Application Priority Data
Feb. 15, 2022 (FR) 22 01310

(51) Int. Cl. G08G 5/04; G08G 5/00

(52) U.S. Cl. CPC G08G 5/04; G08G 5/0013; G08G 5/0078

(57) ABSTRACT

Disclosed is a method for detecting decoying of a traffic alert and collision avoidance system on-board an aircraft targeted by decoying. The method includes a phase of establishing a trusted network including the steps of dividing the space into a plurality of zones; and of selecting a verifier in each zone. The method further includes a phase of validation including the steps of generating an interrogation [sent] to each verifier; [a step of] reception of a response to each interrogation and verifying the response; and [a step of] analysis of all the responses so as to either validate or not validate the aircraft suspected of decoying, as false traffic.

This application claims the priority under 35 U.S.C. 119(a) of French application FR 22 01310, filed Feb. 15, 2022, the entirety of which is incorporated by reference.

### BACKGROUND OF THE INVENTION

### Field of the Invention

The present invention relates to a method for detecting decoying of a traffic alert and collision avoidance system.

The present invention further relates to a traffic alert and collision avoidance system associated with such a method.

The invention belongs to the field of air traffic management and more precisely to the management of air-air collision risks.

### DESCRIPTION OF THE RELATED ART

In a manner known per se, such a risk is first managed by air traffic control. If the above is not enough, the Traffic Collision Avoidance System (TCAS), which is present on-board any commercial aircraft, acts as the last safety net.

In particular, such a TCAS system, on-board an aircraft, is suitable for interrogating the surrounding traffic in order to obtain the different information needed for the operation (relative distance, bearing (angle) and relative altitude between the aircraft) thereof. To this end, the TCAS system interrogates the surrounding transponders by means of the A/C mode and the S mode. Thereby the TCAS system can cover the different types of existing transponders.

The relative distance is calculated by the round-trip time of the interrogation-response with a waiting time before response which varies depending on the communication mode chosen. The bearing is obtained using a directional antenna used for the reception of the response. Altitude is directly provided in the response.

When there is a potential risk of collision, the TCAS system will first generate a TA (Traffic Alert) to warn the pilot about the potential risk. Then, if the risk is still present and confirmed, the risk will generate an RA (Resolution Advisory) which consists in asking the pilot to climb, to descend and/or to stop a descent or a climb. If both aircraft are equipped with a TCAS system, their maneuvers will be coordinated.

The TCAS system was conceived and developed solely in terms of safety but not in terms of security. The main risk of intrusion and decoying is carried by radiofrequency exchanges.

It is e.g. possible for an attacker to simulate the responses of a transponder, in particular by means of a software radio. The TCAS system will interpret such responses as an aircraft of the surrounding traffic which could lead to a traffic alert and even to a resolution advisory. Such maneuver then represents a danger to the surrounding traffic and the aircraft as such.

Currently, there is no solution for the detection of decoying of the TCAS system. However, there are physical limitations restricting decoying, which are a direct consequence of the design of the TCAS system. However, such limitations are not sufficient because there is room to maneuver below same.

Among the documents of the prior the art, document EP 3379295 B1 is known, which proposes to detect false ADS-B (Automatic Dependent Surveillance-Broadcast) signals according to the angle of arrival of the signals. If a false signal is detected, the system will broadcast in a surveillance message that the information is inconsistent. However, ADS-B signals are used by the system only for remote surveillance and do not intervene in the construction of traffic alerts and resolution advisories.

Document EP 3113445 A1 proposes to gather a plurality of potential sources of attack detection and also to compare same with different models. However, such problem does not explicitly address the problem of decoying of the TCAS system.

Document U.S. Ser. No. 10/880,070 B1 proposes to use a blockchain for validating the different exchanges between aircraft, satellites and ground stations. However, such solution involves the different disadvantages of the blockchain on-board the aircraft (constantly growing size of the blockchain, performance for validating new blocks, etc.).

### SUMMARY OF THE INVENTION

The purpose of the present invention is to propose a solution for detecting a decoying of the TCAS system through the cooperation of the aircraft carrying said system with other aircraft and/or one or a plurality of ground stations. Such solution is simple and inexpensive to implement.

To this end, the invention relates to a method for detecting a decoying by a traffic alert and collision avoidance system, called TCAS, TCAS being on-board an aircraft targeted by decoying.

The method comprises a phase of establishing a trusted network and a phase of validation;

the phase of establishing the trusted network comprises the following steps:
division of a space surrounding the targeted aircraft into a plurality of zones;
in at least certain zones, selection of a verifier, each verifier corresponding to another aircraft or to a ground station apt to implement the trusted network;

the phase of validation being initiated with respect to an aircraft suspected of decoying and comprising the following steps:
formation of an interrogation to each verifier, each interrogation containing data relating to the aircraft suspected of decoying;
reception of a response to each interrogation and checking of the response;
analysis of all the responses whether or not to validate the aircraft suspected of decoying as false traffic.

According to other advantageous aspects of the invention, the method comprises one or a plurality of the following features,
each verifier is selected from all aircraft or ground stations in the corresponding zone according to the relative distance to the targeted aircraft;
the phase of establishing the trusted network also includes a step of replacing the verifier of at least one zone by a new verifier when the relative distance between the new verifier and the targeted aircraft becomes less than the relative distance between the targeted aircraft and the old verifier;
the step of selecting a verifier further includes a checking of the legitimacy of the verifier;
the phase of validation is initiated when the aircraft suspected of decoying becomes a threat both in terms of altitude and of distance;
the TCAS system is equipped with an S mode of communication with surrounding aircraft or ground stations;
each interrogation is integrated into data communicated by the S mode of communication;
each interrogation contains at least one of the following elements:
   distance between the verifier and the aircraft suspected of decoying;
   bearing between the verifier and the aircraft suspected of decoying;
   altitude of the aircraft suspected of decoying;
   ICAO address of the aircraft suspected of decoying;
   transponder code of the aircraft suspected of decoying.
the checking of the response to each interrogation comprises a checking of consistency of the angle of reception of signals corresponding to said response with the bearing of the corresponding verifier;
the response to each interrogation comprises one of the following elements:
   validation of the aircraft suspected of decoying as real traffic;
   non-recognition of the aircraft suspected of decoying;
   recognition of the aircraft suspected of decoying as false traffic;
when the response to at least one interrogation comprises a non-recognition of the aircraft suspected of decoying, the analysis step further comprises a checking of the distance between the aircraft suspected of decoying and the corresponding verifier and when said distance is less than a maximum range of an A/C communication mode or an S communication mode of corresponding TCAS systems, a recognition of the aircraft suspected of decoying as false traffic;
the method further comprising a warning phase comprising a step of reception of a warning by a ground station having detected false traffic.

A further subject matter of the present invention is a traffic alert and collision avoidance system, called TCAS, comprising technical means configured for implementing the method for detecting decoying, as described hereinabove.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic view of a traffic alert and collision avoidance system according to the invention;

FIG. 2 is an flow chart of a detection method according to the invention, the method being implemented by the system shown in FIG. 1;

FIGS. 3 to 8 are different schematic views illustrating the implementation of the method shown in FIG. 2.

### DETAILED DESCRIPTION OF THE INVENTION

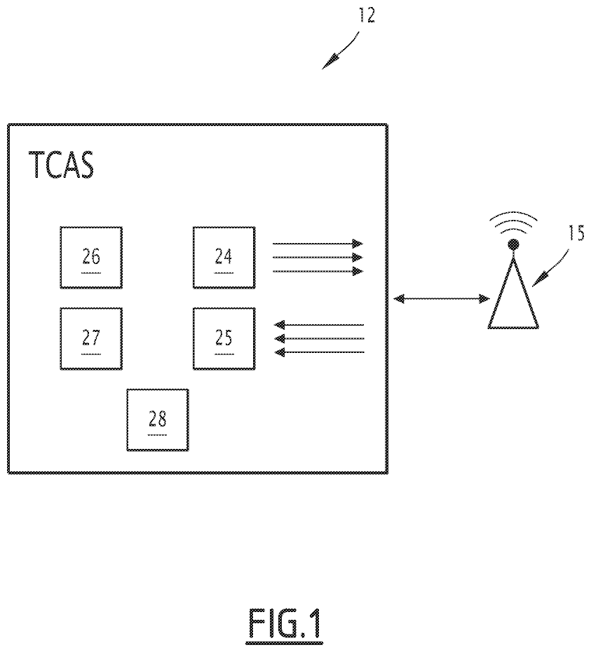

A traffic alert and collision avoidance system 12, called TCAS system 12, according to the invention, is illustrated in FIG. 1.

TCAS system 12 is on-board an aircraft. Aircraft means any craft which can be piloted either from inside thereof or remotely. In the first case, such an aircraft can be piloted by a pilot and can be represented by an airplane, in particular an airliner, a cargo aircraft or then a military aircraft, or a helicopter. In the second case, such an aircraft can be piloted by a remote operator and can be represented by a drone.

In a manner known per se, the TCAS system 12 makes it possible to avoid collisions with surrounding aircraft located with respect to the aircraft carrying said TCAS system 12, within a radius of predetermined length. The predetermined length is e.g. less than or equal to 15 NM, advantageously less than or equal to 10 NM. Among the surrounding aircraft, an aircraft presenting a threat of collision is called an intruder aircraft.

The TCAS system 12 is connected to an antenna 15 apt to transmit and receive radio signals carrying mode S and mode A/C data, as will be explained thereafter. The antenna 15 is also on-board the aircraft.

In order to communicate with the surrounding aircraft via the antenna 15, the TCAS system 12 comprises an interrogation module 24 and a reception module 25 which can be used correspondingly for interrogating the aircraft and for receiving responses therefrom using mode S data and mode A/C data

In particular, in order to communicate with the surrounding aircraft using the A/C mode, the interrogation module 24 is apt to send interrogations to the aircraft, via the antenna 15, according to a mode A or a mode C known per se.

Similarly, in order to communicate with the surrounding aircraft using the S mode, the interrogation module 24 is apt to send interrogations to said aircraft, via the antenna 15, according to a mode S known per se.

The reception module 25 is apt to receive, via the antenna 15, responses to all the interrogations sent by the interrogation module 24 and of deducing therefrom, data relating to the aircraft having responded to the given interrogation.

In particular, by implementing communication through mode A, the interrogation module 24 can send to mode A transponders of the surrounding aircraft, “Mode-A Only All-Call” interrogations and the reception module 25 can receive messages containing the transponder codes in response to the mode A transponders. Each transponder code then presents an identifier of the transponder which responded to the interrogation. Furthermore, each Mode A transponder has a fixed time for responding to the interrogation. Such time is substantially equal to 3 microseconds.

Thereby, by knowing the response time and the direction of the origin of the mode A response signals (e.g. by means of a directional antenna), the reception module 25 is apt to determine a relative distance from each surrounding aircraft as well as a bearing of said aircraft.

Similarly, by implementing communication in mode C, the interrogation module 24 can send “Mode-C Only All-Call” interrogations to mode C transponders of the surrounding aircraft, and the reception module 25 receives messages containing altitudes of the surrounding aircraft in response to the mode C transponders. Like in mode A, each mode C transponder has a fixed time for responding to the interrogation. Such time is substantially equal to 3 microseconds.

By knowing the response time and the direction of the origin of the mode C response signals, the reception module 25 is apt to determine a relative distance from each surrounding aircraft as well as the bearing thereof. Furthermore, as indicated above, the altitude of each aircraft which responded to the interrogation is contained in the mode C message transmitted for the corresponding mode C transponder.

By implementing a communication in mode S, the interrogation module 24 sends interrogations of more complex form to the mode S transponders of the surrounding aircraft and the reception module 25 thus receives more information concerning each surrounding aircraft.

Thereby e.g. when the interrogation module 24 sends a “Short Air-Air Surveillance” interrogation, the reception module 25 receives from each surrounding aircraft, a message containing:
An ICAO (International Civil Aviation Organization) address of the surrounding aircraft;
the Vertical Status thereof;
the Cross-link Capability thereof;
the Sensitivity Level thereof;
the altitude thereof;
the Reply Information.

The interrogation module 24 is further apt to send “Mode-S Only All-Call” and “Long Air-Air Surveillance” interrogations and the reception module 25 is apt to receive and process responses to said interrogations.

Like in the case of the A/C transponder, each mode S transponder has a fixed time for responding to each interrogation. Such time is substantially equal to 128 microseconds.

Also like in the preceding cases, knowing the response time and the direction of the origin of the mode S response signals, the reception module 25 is apt to determine a relative distance from each surrounding aircraft as well as the bearing thereof.

A potential attacker could distort the position of an aircraft with respect to the aircraft carrying the TCAS system 12 by responding to the interrogations, sent via mode S, of the latter after a response time other than the time mentioned hereinabove. In particular, an attacker could respond to such an interrogation after a shorter time interval, which would result in determining the relative distance as being shorter than in reality.

The TCAS system 12 according to the invention, can prevent such a case and in particular [can prevent] the detection of a decoying originating from an aircraft or any other radio station, the purpose of which is to distort the relative distance to said aircraft or said station. When such decoying is detected, the intruder aircraft the position of which is distorted, is then considered to be false traffic. Otherwise, the intruder aircraft is thus real traffic.

To this end, the TCAS system 12 according to the invention further comprises a communication module 26 and a validation module 27.

The communication module 26 enables the aircraft carrying the TCAS system 12 to establish a trusted network with surrounding aircraft and/or one or a plurality of ground stations. In particular, it will be considered thereafter that aircraft which establish such a trusted network also carry a TCAS system similar to the TCAS system 12 described hereinabove. As for the ground stations, to be integrated into a trusted network, same are configured for implementing functions similar to the functions of a TCAS system 12, in particular with regard to the trusted network, as will also be explained thereafter.

The validation module 27 detects decoying by analyzing responses to at least certain interrogations received from the aircraft/ground stations of the trusted network.

Furthermore, in order to provide at least certain functions of the communication 26 and validation 27 modules, the interrogation 24 and reception 25 modules of the TCAS system according to the invention, send specific interrogations and receive responses to the interrogations via modes A, C or S. Said interrogations are not programmed in current TCAS systems and are sent according to the detection method described in detail hereinafter.

Finally, the TCAS system 12 according to the invention further comprises a display module 28 which displays or indicate in any other way to the pilot or to the operator, a result of the detection method according to the invention.

The modules 24 to 28 correspond e.g. to different computer modules programmed within the TCAS system 12. According to another embodiment, at least certain of said modules have at least partially, a programmable logic circuit, e.g. such as FPGA (Field Programmable Gate Array).

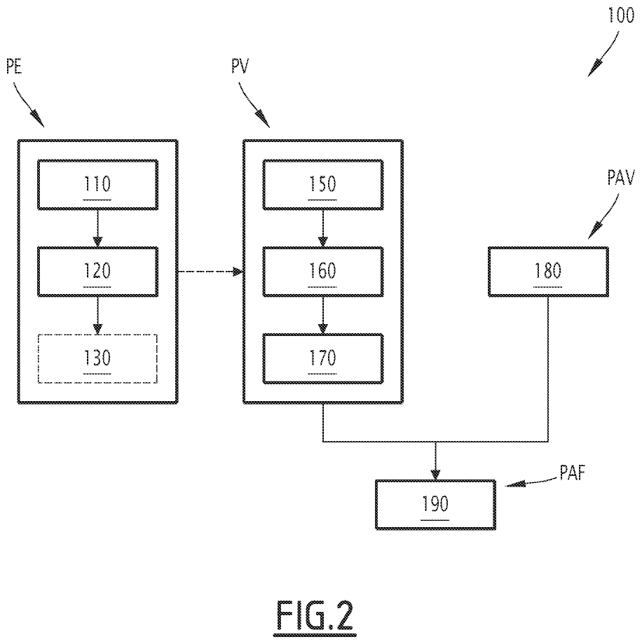

The detection method 100 according to the invention will henceforth be explained with reference to FIG. 2 which shows a flow chart of the steps thereof.

In particular, with reference to said figure, the detection method 100 comprises a phase of establishing a trusted network PE, a phase of validation PV, a warning phase PAV and a display phase PAF.

The phase of establishing a trusted network PE is periodically implemented e.g. by the communication module 26 for initially establishing such a trusted network and then following the evolution thereof.

The phase of validation PV is implemented by the validation module 27 in relation to each aircraft suspected of decoying after the phase of establishing PE a trusted network has been implemented at least once. Furthermore, advantageously according to the invention, the phase of validation of a trusted network PV is implemented when the aircraft suspected of decoying becomes a threat both in terms of altitude and of distance.

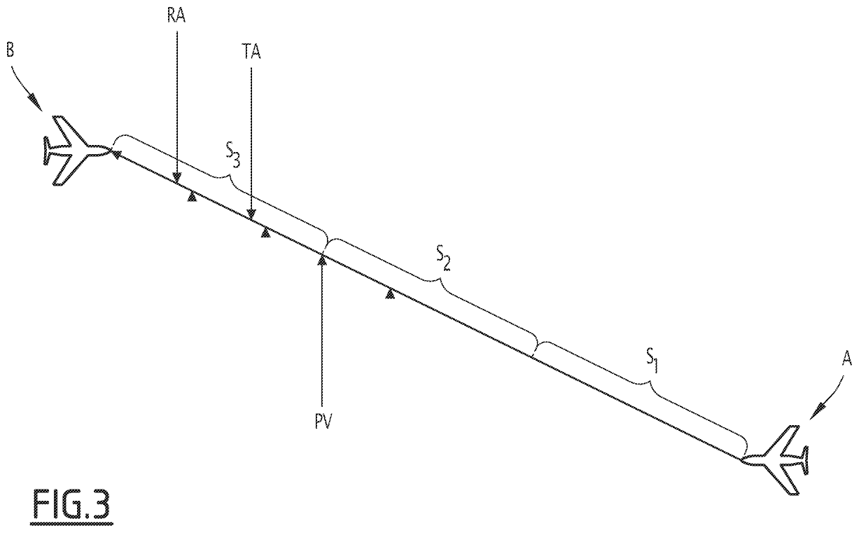

With reference to FIG. 3, segment S1 corresponds to the situation when the aircraft A suspected of decoying, is far from aircraft B carrying the TCAS system 12, also called the targeted aircraft, by more than a safety distance. The safety distance is e.g. 10 NM. Segment S2 corresponds to the situation when the aircraft A suspected of decoying poses a threat in terms of altitude or of relative distance to the targeted aircraft B. Finally, segment S3 corresponds to the situation when the aircraft suspected of decoying poses a threat both in terms of altitude and of distance. The phase of validation PV is thus initiated when the aircraft suspected of decoying enters segment S3. It should also be noted that when aircraft A continues to approach aircraft B, segment S1 comprises the triggering of a traffic alert TA and then of a resolution advisory RA.

The warning phase PAV is independent of the two phases PE and PV and is implemented when a ground station detects false traffic as will be explained thereafter. Such phase is e.g. implemented by the communication module 26 communicating with one or a plurality of ground stations.

Finally, the display phase PAF is implemented when false traffic has been detected during the phase of validation PV or during the warning phase PAV. The display phase is implemented by the display module 28.

During an initial step 110 of the phase of establishing PE a trusted network, the TCAS system 12 of the targeted aircraft divides the surrounding space thereof into a plurality of zones. The surrounding space can e.g. be formed by a radius limiting the transmission range of the various TCAS systems.

The number of surrounding zones can e.g. change depending upon the density of traffic, the number of aircraft/ground stations implementing the trusted network, the configuration of the different aircraft/ground stations or further a number of zones defined in advance in the TCAS system 12.

In the following examples, it is considered that the surrounding space is divided into four zones. Said zones are defined e.g. by dividing the surrounding space along the longitudinal axis and the transverse axis of the targeted aircraft.

During the next step 120, in at least certain zones, the TCAS system 12 selects a verifier. In particular, each verifier corresponds to another aircraft or to a ground station apt to implement the trusted network.

In order to discover such aircraft/ground stations in the surrounding space, the TCAS system 12 of the targeted aircraft can send an All-Call interrogation via the interrogation module 24 thereof using mode S. A response to said interrogation is sent only by aircraft/ground stations apt to implement a trusted network. In certain embodiments, such information is directly integrated into the various frames of the S mode or of the ADS-B (“Automatic dependent Surveillance Broadcast”) system, in particular by means of techniques for increasing the information contained in the frames, such as the “phase overlay” technique.

It is also conceivable to use other means of communication between aircraft/ground stations, such as communications with satellites, intermediate ground stations or other types of communication between aircraft.

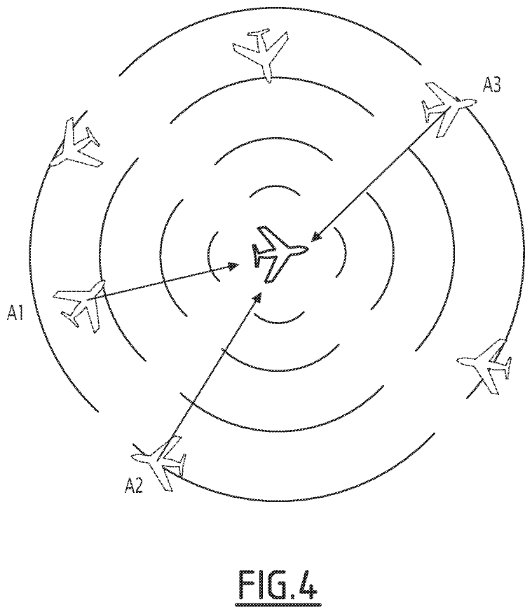

In the example shown in FIG. 4, only aircraft A1 to A3 responded to the TCAS system 12 of the targeted aircraft shown in the center of the figure. Thus, only the aircraft A1 to A3 can form a trusted network according to the present example.

Furthermore, each verifier is selected from all aircraft or ground stations in the corresponding zone depending on the relative distance to the targeted aircraft. Advantageously, among all the aircraft or ground stations in the corresponding zone, the verifier has the shortest relative distance to the targeted aircraft.

Advantageously, the legitimacy of each verifier is checked by protection means of the TCAS system 12, included e.g. in the communication module 26. Such means e.g. can implement a specific communication according to mode A or mode C, and/or implement a behavioral analysis. The TCAS system 12 then checks each verifier in turn with the other verifiers so as to increase the level of trust in the verifier.

If TCAS does not find a verifier in a zone, said zone will be unusable for checking the aircraft suspected of decoying. Said zone will become usable again when a potential verifier will enter the zone and will pass the checking tests.

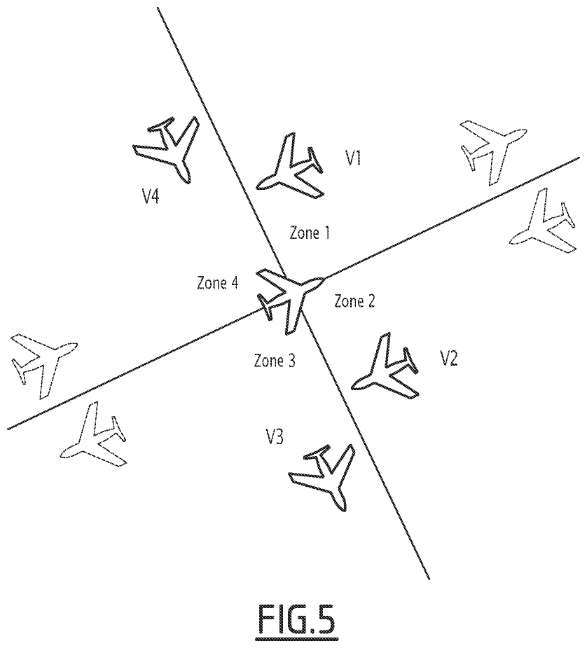

In the example shown in FIG. 5, four verifiers V1 to V4 are selected for the four zones, Zone 1 to Zone 4.

The establishment phase PE can further comprise a step 130 of replacing the verifier of at least one zone by a new verifier, when e.g. the phase PE is repeated after a first implementation.

The old verifier e.g. is replaced when the relative distance between the new verifier and the targeted aircraft becomes less than the relative distance between the targeted aircraft and the old verifier.

During the initial step 150 of the phase of validation PV which is, as mentioned hereinabove, implemented in relation to an aircraft suspected of decoying, the TCAS system 12 of the targeted aircraft, generates an interrogation to each verifier. Each interrogation contains data relating to the aircraft suspected of decoying.

Each interrogation e.g. contains at least one of the following elements, advantageously 2, 3, 4 or all elements:
distance between the verifier and the aircraft suspected of decoying;
bearing between the verifier and the aircraft suspected of decoying;
altitude of the aircraft suspected of decoying;
ICAO address of the aircraft suspected of decoying;
transponder code of the aircraft suspected of decoying.

According to one embodiment, each interrogation is directly implemented through a change of the existing S mode which would result in the increase of the information contained in frames, in particular due to the “phase overlay” technique. The above could be the subject of a change of the “Long Air-Air Surveillance” messages so as to directly integrate said interrogation.

According to another embodiment, each interrogation is implemented via other means of communication such as communications via satellites, ground stations or other types of communication between aircraft.

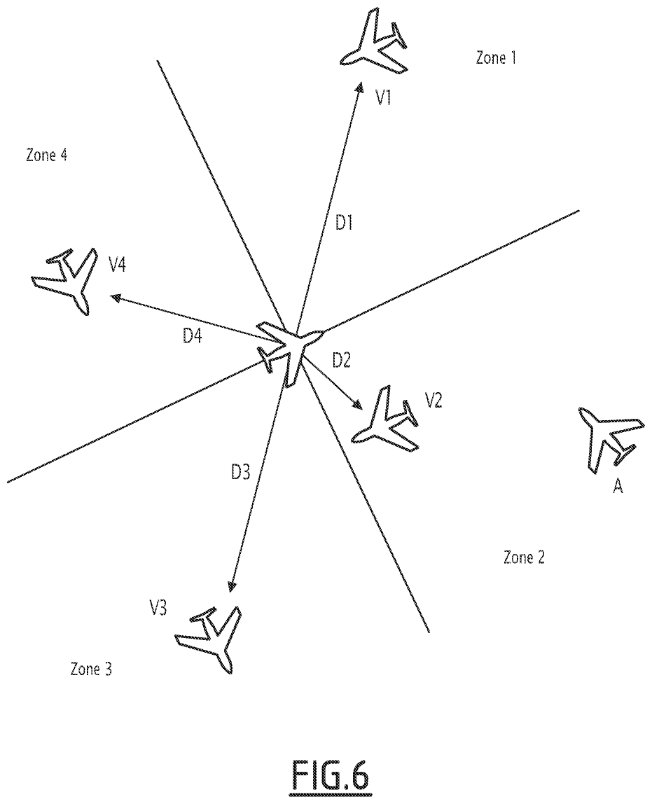

In the example shown in FIG. 6, the TCAS system 12 of the aircraft shown in the center of the figure, sends data D1 to D4 to verifiers V1 to V4 respectively. Such data relate to the aircraft A suspected of decoying.

During the same step, each verifier receives the interrogation and first verifies the legitimacy of the interrogation. To this end, the verifier can check e.g. that the angle of arrival of signals corresponding to the interrogation is consistent with the bearing of the interrogator, i.e. of the aircraft carrying the TCAS system 12.

In a second step, each verifier checks that he/she knows the aircraft suspected of decoying. When e.g. the aircraft suspected of decoying has been detected by the interrogator's mode S, it has to be checked, in particular, that TCAS system or the analogue thereof of the verifier, carefully monitors the ICAO address of the aircraft suspected of decoying, and then if this is the case, the veracity of each of the data transmitted by the interrogator has to be checked. In a variant, when the aircraft suspected of decoying has been detected by the A/C mode, it has to be checked whether the data transmitted by the interrogator is consistent with the surrounding traffic in A/C mode. The verifier has to make sure that the aircraft suspected of decoying has not been recognized as false traffic by the own decoying detection means thereof.

Three results are then possible. The first result is the normal case where the aircraft suspected of decoying is known and the data thereof are valid. In such case, the verifier responds to the interrogation so as to confirm real traffic. The second result corresponds to the case where the verifier does not know the aircraft suspected of decoying, the verifier then responds that the aircraft suspected of decoying is unknown. The third case is when the aircraft suspected of decoying is known but the data thereof transmitted by the interrogator are not valid. In such a case, the verifier responds that the aircraft suspected of decoying is false traffic.

In all three cases, the response is sent directionally and towards the interrogator, when communication with the interrogator is implemented in the S mode.

During the next step 160, the TCAS system 12 receives a response to each interrogation and implements a checking of said response.

The checking comprises e.g. checking the consistency of the angle of reception of signals corresponding to each response, with the bearing of the verifier.

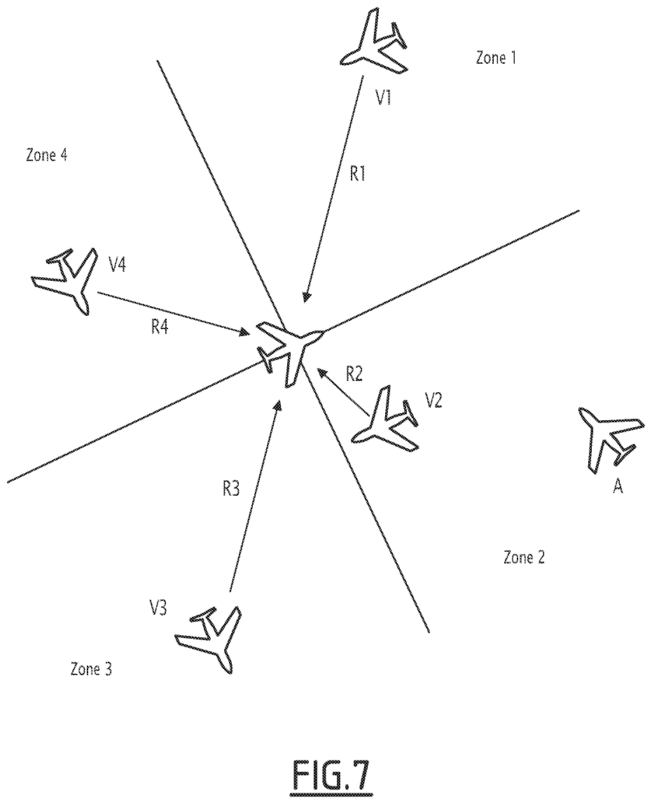

In FIG. 7, the TCAS system 12 of the aircraft shown in the center of the figure, receives responses R1 to R4 from verifiers V1 to V4, respectively, with regard to the aircraft A suspected of decoying.

During the next step 170, the TCAS system 12 analyzes all the responses to validate or not validate the aircraft suspected of decoying, as false traffic.

In particular, as noted above, the response to each interrogation comprises one of the following elements:
validation of the aircraft suspected of decoying as real traffic;
non-recognition of the aircraft suspected of decoying;
recognition of the aircraft suspected of decoying, as false traffic.

When all the responses validate the aircraft suspected of decoying as real traffic, said aircraft is then also considered by the TCAS system 12 as real traffic.

When the response to at least one interrogation comprises a non-recognition of the aircraft suspected of decoying, the TCAS system 12 checks the distance between the aircraft suspected of decoying and the corresponding verifier and when said distance is less than a maximum range of an A/C communication mode or an S communication mode of corresponding TCAS systems, recognizes the aircraft suspected of decoying as false traffic. Otherwise, i.e. where the aircraft suspected of decoying is beyond the range of the verifier's TCAS system, said response is discarded.

When the response to at least one interrogation comprises a recognition of the aircraft suspected of decoying, as false traffic, the TCAS system 12 can also consider the aircraft suspected of decoying, as false traffic or then continue the analysis of the other responses. In the latter case, a degree of confidence can be associated with each response and a final decision can be made depending on said degrees.

In addition, a degree of confidence can also be associated with each response in the preceding case, i.e. when the response to at least one interrogation comprises a non-recognition of the aircraft suspected of decoying. In such a case, the final decision is also made according to said degrees.

The warning phase PAV comprises a step 180 during which the TCAS system 12 receives a warning from a ground station which has detected false traffic. Such false traffic is e.g. detected by the ground station independently implementing its own detection means thereof or else detection means working in collaboration with other ground stations and/or aircraft.

Regardless of the technique applied by the ground station for detecting false traffic, the data exchanged between the ground station and the targeted aircraft can be securely exchanged by suitable means of communication.

Such means of communication can correspond to existing means such as aeronautical short-distance ground-on-board data links (ACARS, ADS-C, CPDLC, etc.) or long-distance data links such as SATCOM (Inmarsat, Iridium, etc.).

It can be further conceivable to use other means of communication which would provide greater confidence in the security of the information transmitted. Indeed, it will be necessary to make sure that such links cannot be corrupted. In the case where such confidence cannot be provided, the systems receiving the information about the false traffic can simply accept the information for informational purposes (not reject a traffic following such information) and seek by their own means thereof to detect that false traffic is concerned. If the communication is secure (authenticated and intact), it is thus possible for the system receiving the information to consider the traffic as false traffic.

As indicated hereinabove, when false traffic is detected, the method 100 further comprises a display phase PAF which then comprises a step 190 of displaying in the TCAS system 12, a symbol representative of the false traffic. The step 190 is implemented by the display module 27.

Advantageously, according to the invention, the symbol of the false traffic displayed by the display module 27 is different from a symbol representative of any other aircraft the mode S data of which have been validated, i.e. of any other aircraft considered to be true traffic.

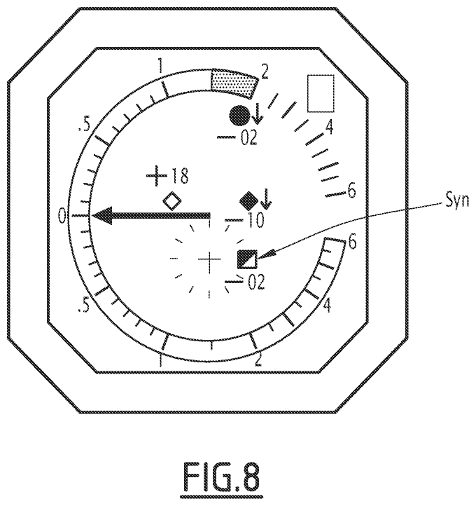

With reference e.g. to FIG. 8 showing an example of the TCAS system 12 display, the Syn symbol represents false traffic. Said symbol has a shape usually used for representing real traffic (i.e. a square e.g.) but defines a feature (such as a color) for notifying the pilot or the operator that false traffic is concerned, according to the validation module 27. In the example shown in FIG. 8, one half of the square is colored in a normal color (red e.g.) and the other half in a different color. Thus, the pilot or operator is warned that there is false traffic without losing sight of the traffic.

It can be then understood that the invention has a certain number of advantages.

In particular, the invention can be used for detecting decoying of a TCAS system in a collaborative manner between a plurality of aircraft and/or ground stations. Such collaboration is implemented using existing systems, which greatly simplifies the implementation thereof. Moreover, it is possible to make the exchanged information more secure and intact, by improving the security of the various means of communication used.

1. A method for detecting decoying in a traffic alert and collision avoidance system, called TCAS;
the TCAS system being carried on-board an aircraft targeted by decoying;
the method comprising a phase of establishing a trusted network and a phase of validation;
the phase of establishing the trusted network comprising the following steps:
division of a surrounding space of the targeted aircraft into a plurality of zones;
in at least certain zones, selection of a verifier, each verifier corresponding to another aircraft or to a ground station able to implement the trusted network;
the phase of validation being initiated with respect to an aircraft suspected of decoying and comprising the following steps:
formation of an interrogation to each verifier, each interrogation containing data relating to the aircraft suspected of decoying;
reception of a response to each interrogation and checking of the response;
analysis of all the responses so as to either validate or not validate the aircraft suspected of decoying as false traffic;
wherein each verifier is selected from all aircrafts or ground stations in the corresponding zone depending on the relative distance to the targeted aircraft.

2. The method for detecting decoying according to claim 1, wherein the phase of establishing the trusted network further comprises a step of replacing the verifier of at least one zone by a new verifier when the relative distance between the new verifier and the targeted aircraft becomes less than the relative distance between the targeted aircraft and the old verifier.

3. The method for detecting decoying according to claim 1, wherein the step of selection of a verifier further comprises checking the legitimacy of the verifier.

4. The method for detecting decoying according to claim 1, wherein the phase of validation is initiated when the aircraft suspected of decoying becomes a threat both in terms of altitude and of distance.

5. The method for detecting decoying according to claim 1, wherein:
the TCAS system is equipped with an S mode of communication with surrounding aircrafts or ground stations;
each interrogation is integrated into data communicated by the S mode.

6. The method for detecting decoying according to claim 1, wherein each interrogation contains at least one of the following elements:
distance between the verifier and the aircraft suspected of decoying;
bearing between the verifier and the aircraft suspected of decoying;
altitude of the aircraft suspected of decoying;
ICAO address of the aircraft suspected of decoying;
transponder code of the aircraft suspected of decoying.

7. The method of detecting decoying according to claim 1, wherein the checking of the response to each interrogation comprises a checking of consistency of the angle of reception of signals corresponding to said response with the bearing of the corresponding verifier.

8. The method for detecting decoying according to claim 1, wherein the response to each interrogation comprises one of the following elements:
validation of the aircraft suspected of decoying as real traffic;
non-recognition of the aircraft suspected of decoying;
recognition of the aircraft suspected of decoying, as false traffic.

9. The method for detecting decoying according to claim 8, wherein the response to at least one interrogation comprises a non-recognition of the aircraft suspected of decoying, the analysis step further comprising a checking of the distance between the aircraft suspected of decoying and the corresponding verifier and when said distance is less than a maximum range of an A/C communication mode or an S communication mode of corresponding TCAS systems, a recognition of the aircraft suspected of decoying as false traffic.

10. The method for detecting decoying according to claim 1, further comprising a warning phase comprising a step of reception of a warning by a ground station having detected false traffic.

11. A traffic alert and collision avoidance system, called TCAS, comprising an interrogation module, a reception module, a communication module, a validation module and a display module, configured for implementing the method for detecting decoying according to claim 1.
